(19) United States
(12) Patent Application Publication
(10) Pub. No.: US 2026/0254287 A1
(43) Pub. Date: Aug. 27, 2026

(54) CHARGING DEVICE

(71) Applicant: Panasonic Automotive Systems Co., Ltd., Kanagawa (JP)

(72) Inventor: Yoshio YUSE, Tokyo To (JP)

(73) Assignee: Panasonic Automotive Systems Co., Ltd., Kanagawa (JP)

(21) Appl. No.: 19/460,958

(22) Filed: Jan. 27, 2026

(30) Foreign Application Priority Data
Feb. 25, 2025 (JP) 2025-027715

(51) Int. Cl. H02J 50/90; H02J 7/70; H02J 50/10; H02J 50/60

(52) U.S. Cl. CPC H02J 50/90; H02J 7/731; H02J 50/10; H02J 50/60

(57) ABSTRACT

A charging device according to an embodiment performs wireless charging for a terminal device placed on a charging stand. The terminal device includes a power reception coil to receive wirelessly transmitted power. The charging device includes a power transmission coil and a control circuit connected to the power transmission coil. The power transmission coil transmits power to the terminal device. The control circuit acquires an operating voltage of the charging device and received power of the terminal device after the charging device starts the wireless charging for the terminal device. The control circuit calculates a first reference voltage of the charging device used for misalignment determination. The control circuit determines a misalignment between the power transmission coil and the power reception coil based on a first voltage difference indicating a difference between the operating voltage of the charging device and the first reference voltage.

### CROSS-REFERENCE TO RELATED APPLICATIONS

This application is based upon and claims the benefit of priority from Japanese Patent Application No. 2025-027715, filed on February 25, 2025, the entire contents of which are incorporated herein by reference.

### FIELD

The present disclosure relates generally to a charging device.

### BACKGROUND

A charging device has been known, which moves a power transmission coil to a position of a power reception coil of a terminal device with a built-in battery and wirelessly charges the terminal device with the power transmission coil (See, for example, Patent Literature: JP 2013-128400 A).

In such a charging device, an induced electromotive force by electromagnetic induction is generated by causing a magnetic flux generated by an alternating current flowing in the power transmission coil to pass through the power reception coil built in the terminal device placed on a charging stand. Then, the terminal device is charged by the induced electromotive force generated in the power reception coil.

When determining a foreign object present between the charging device and the terminal device, the charging device performs, for example, foreign object determination in consideration of received power of the terminal device.

In a case where a misalignment between the power transmission coil and the power reception coil occurs, or in a case where a foreign object is inserted between the power transmission coil and the power reception coil, power efficiency is lowered.

Therefore, in wireless charging, there is room for further improvement in power efficiency.

### SUMMARY

A charging device according to an embodiment performs wireless charging for a terminal device placed on a charging stand. The terminal device includes a power reception coil to receive wirelessly transmitted power. The charging device includes a power transmission coil and a control circuit connected to the power transmission coil. The power transmission coil is configured to transmit power to the terminal device. The control circuit is configured to acquire an operating voltage of the charging device and received power of the terminal device after the charging device starts the wireless charging for the terminal device. The control circuit is configured to calculate a first reference voltage of the charging device used for misalignment determination. The control circuit is configured to determine a misalignment between the power transmission coil and the power reception coil based on a first voltage difference indicating a difference between the operating voltage of the charging device and the first reference voltage.

### BRIEF DESCRIPTION OF THE DRAWINGS

FIG. 1 is a diagram illustrating an example of a schematic configuration of a charging system according to an embodiment;

FIG. 2 is a block diagram illustrating an example of a functional configuration of a control unit according to the embodiment;

FIG. 3 is a schematic diagram for describing a misalignment characteristic according to the embodiment;

FIG. 4 is a schematic diagram for describing the misalignment characteristic according to the embodiment;

FIG. 5 is a schematic diagram for describing a state of a misalignment between a power transmission coil and a power reception coil according to the embodiment;

FIG. 6 is a schematic diagram for describing details of the misalignment between the power transmission coil and the power reception coil according to the embodiment;

FIG. 7 is a schematic diagram for describing the details of the misalignment between the power transmission coil and the power reception coil according to the embodiment;

FIG. 8 is a schematic diagram for describing the details of the misalignment between the power transmission coil and the power reception coil according to the embodiment;

FIG. 9 is a schematic diagram for describing the details of the misalignment between the power transmission coil and the power reception coil according to the embodiment;

FIG. 10 is a flowchart illustrating an example of a procedure of processing performed by the charging device according to the embodiment;

FIG. 11 is a flowchart illustrating an example of a procedure of processing performed by the charging device according to the embodiment;

FIG. 12 is a flowchart illustrating an example of a procedure of processing performed by the charging device according to the embodiment;

FIG. 13 is a flowchart illustrating an example of a procedure of processing performed by the charging device according to the embodiment;

FIG. 14 is a flowchart illustrating an example of a procedure of processing performed by the charging device according to the embodiment;

FIG. 15 is a flowchart illustrating an example of a procedure of processing performed by the charging device according to the embodiment;

FIG. 16 is a flowchart illustrating an example of a procedure of processing performed by the charging device according to the embodiment;

FIG. 17 is a flowchart illustrating an example of a procedure of processing performed by the charging device according to the embodiment;

FIG. 18 is a flowchart illustrating an example of a procedure of processing performed by a charging device according to a first modified example; and

FIG. 19 is a diagram illustrating an example of a hardware configuration of the charging system according to the embodiment and the modified examples.

### DETAILED DESCRIPTION

### Embodiment

Hereinafter, an embodiment of a charging device according to the present disclosure will be described with reference to the drawings.

In the description of the present disclosure, constituent elements having the same or substantially the same functions as those described above with reference to the previously described drawings are denoted by the same reference numerals, and the description thereof may be appropriately omitted. In addition, even in the case of representing the same or substantially the same part, the dimensions and ratios may be expressed differently from each other depending on the drawings. Moreover, in order to ensure visibility of the drawings, in the description of each drawing, only main constituent elements are denoted by reference numerals, and even constituent elements having the same or substantially the same functions as those described above in the previous drawings may not be denoted by reference numerals.

In the description of the present disclosure, constituent elements having the same or substantially the same function may be distinguishably described by adding alphanumeric characters to the end of reference numerals. Alternatively, in a case where constituent elements having the same or substantially the same function are not distinguished, the constituent elements may be collectively described by omitting alphanumeric characters added to the end of the reference numerals.

There is known a charging device that moves a power transmission coil to a position of a power reception coil of a terminal device with a built-in battery and wirelessly charges the terminal device with the power transmission coil. In such a charging device, an induced electromotive force by electromagnetic induction is generated by causing a magnetic flux generated by an alternating current flowing in the power transmission coil to pass through the power reception coil built in the terminal device placed on a charging stand. Then, the terminal device is charged by the induced electromotive force generated in the power reception coil.

When determining a foreign object present between the charging device and the terminal device, the charging device performs, for example, foreign object determination in consideration of received power of the terminal device. In a case where a misalignment between the power transmission coil and the power reception coil occurs, or in a case where a foreign object is inserted between the power transmission coil and the power reception coil, power efficiency is lowered. Therefore, in wireless charging, there is room for further improvement in power efficiency.

Moreover, for example, a charging device installed in a vehicle, a terminal device placed on a charging stand may be displaced due to vibration or the like caused by a condition of a road on which the vehicle travels (such as, a curve of the road or a road surface condition) at the time of charging in the vehicle, and power efficiency of wireless charging may thus be lowered. The charging device accurately detects the misalignment between the charging device and the terminal device, thereby leading to improvement in charging stability and robustness.

Further, for example, the charging device is required to achieve high alignment accuracy between the power transmission coil and the power reception coil according to the Qi standard. When the power reception coil is misaligned with the power transmission coil, the power efficiency is lowered. Therefore, charging is switched from high-power charging to low-power charging. Accordingly, it is desirable to quickly detect a slight misalignment, correct the misalignment, and continue the high-power charging.

Therefore, in the present disclosure, a charging device capable of improving power efficiency in wireless charging as compared with the related art will be described.

### Embodiment

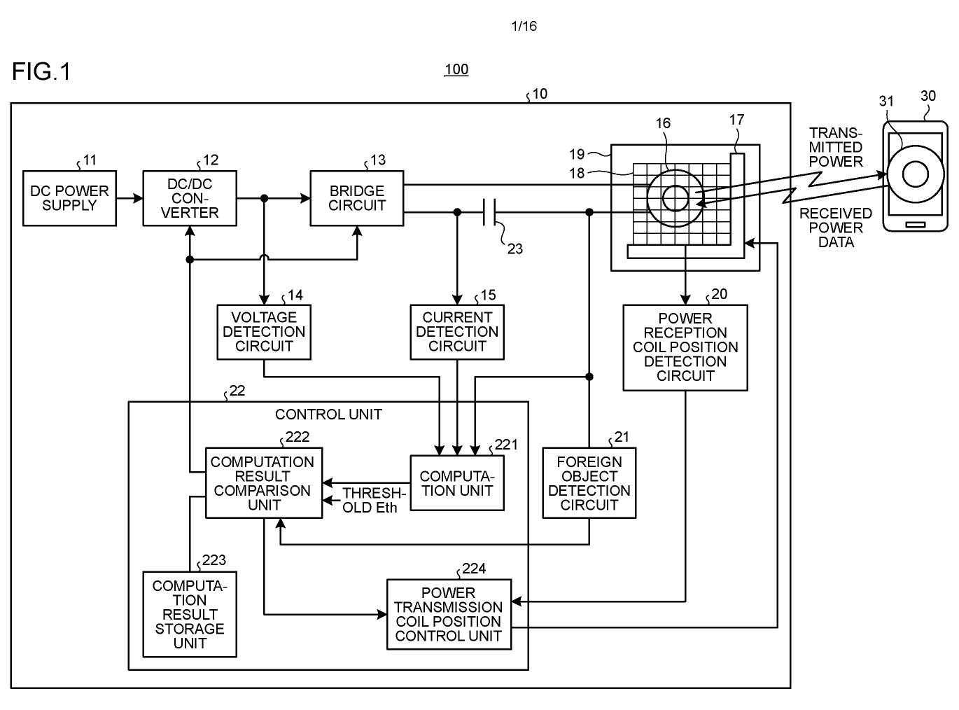

FIG. 1 is a diagram illustrating an example of a schematic configuration of a charging system 100 according to an embodiment. As illustrated in FIG. 1, the charging system 100 includes a charging device 10 and a terminal device 30. The charging device 10 is installed in a vehicle. Here, examples of the vehicle can include a passenger car, a freight vehicle, a van, a motorcycle, an electric kick scooter, a construction machine, an agricultural machine, and an aircraft. In the present embodiment, a form in which one charging device 10 is provided for one vehicle will be described.

The charging device 10 is a device that performs contactless charging, that is, wireless charging, on the terminal device 30. Here, the wireless charging means charging performed in a wireless manner. In the present disclosure, a form in which the wireless charging means charging performed by electromagnetic induction will be described as an example.

As an international standard for the wireless charging, the Qi standard has been established by the Wireless Power Consortium (WPC). The Qi standard defines charging by low-power transfer (hereinafter, referred to as "low-power charging") and charging by high-power transfer (hereinafter, referred to as "high-power charging"). The low-power charging is performed at, for example, a maximum of 5 W, and the high-power charging is performed at a maximum of 15 W. The low-power charging is called a baseline power profile (BPP), and the high-power charging is called an extended power profile (EPP).

In such wireless charging, as an example, a power transmission coil 16 of the charging device 10 is moved by a movement mechanism 17 and brought close to a power reception coil 31 of the terminal device 30 in a state where the terminal device 30 to be charged is placed on an upper surface of a placement part of the charging device 10, thereby aligning the power transmission coil 16 and the power reception coil 31.

In the wireless charging, the more accurately the power transmission coil 16 of the charging device 10 and the power reception coil 31 of the terminal device 30 to be charged face each other, the more efficient the charging is. In the Qi standard, a magnetic power profile (MPP) of high-speed charging using a magnet for alignment is in the process of being standardized. Therefore, the charging device 10 according to the present disclosure may include a magnet disposed together with the power transmission coil 16.

As the terminal device 30 to be charged by the charging device 10, for example, various types of electronic equipment with a built-in battery, such as a smartphone, a tablet terminal, an audio player, and a mobile phone, can be appropriately used.

The charging device 10 includes a direct current (DC) power supply 11, a DC-DC converter 12, a bridge circuit 13, a voltage detection circuit 14, a current detection circuit 15, the power transmission coil 16, the movement mechanism 17, a position detection controller 18, a power reception coil position detection circuit 20, a foreign object detection circuit 21, and a control unit 22.

The DC power supply 11 supplies DC power for operating the charging device 10.

The DC-DC converter 12 steps up or down a DC voltage of the DC power supply 11 to a predetermined DC voltage.

The bridge circuit 13 converts the DC voltage stepped up or down by the DC-DC converter 12 into an AC voltage. The bridge circuit 13 may be a full-bridge circuit or a half-bridge circuit.

The voltage detection circuit 14 detects the DC voltage stepped up or down by the DC-DC converter 12.

The current detection circuit 15 detects an output current of the bridge circuit 13.

The power transmission coil 16 generates a magnetic flux based on the principle of electromagnetic induction according to an alternating current (AC) voltage applied from the bridge circuit 13. The generated magnetic flux passes through the power reception coil 31 included in the terminal device 30 placed so as to overlap the power transmission coil 16, thereby generating an induced electromotive force in the power reception coil 31. The built-in battery of the terminal device 30 is charged by the induced electromotive force generated at this time. That is, power is transmitted from the power transmission coil 16 to the power reception coil 31. In addition, communication based on the Qi standard is performed from the power reception coil 31 to the power transmission coil 16, and for example, the amount of power received by the power reception coil 31 is transmitted.

The movement mechanism 17 moves a position of the power transmission coil 16 in two-dimensional coordinates including a coil surface. The movement mechanism 17 moves the power transmission coil 16 along an X axis and a Y axis by an operation of a servomotor controlled by a position control circuit 38 described below. The servomotor is, for example, an actuator.

The position detection controller 18 includes a plurality of pattern coils, and the power reception coil position detection circuit 20 detects a reflected wave that changes according to a coupling state between the pattern coils and the power reception coil 31 according to a pulse output from a pulse output circuit (not illustrated) connected to each pattern coil.

The power transmission coil 16, the movement mechanism 17, and the position detection controller 18 are included in a charging stand 19. An upper surface of the charging stand 19 forms a plane on which the terminal device 30 can be placed.

The power reception coil position detection circuit 20 detects a position of the power reception coil 31. In one example, the power reception coil position detection circuit 20 acquires the reflected wave from the position detection controller 18, and detects a center position of the power reception coil 31.

The foreign object detection circuit 21 performs foreign object detection processing. Specifically, when the bridge circuit 13 applies the AC voltage to the power transmission coil 16 while changing a frequency, the foreign object detection circuit 21 calculates the sharpness (Q value) of a series resonance state due to a capacitive component (capacitance) of a capacitor 23 connected in series between the bridge circuit 13 and the power transmission coil 16 and an inductive component (inductance) of the power transmission coil 16.

The control unit 22 (an example of the control circuit) performs various controls related to a state of charge by the charging device 10.

The control unit 22 includes a computation unit 221, a computation result comparison unit 222, a computation result storage unit 223, and a power transmission coil position control unit 224.

The computation unit 221 calculates transmitted power to be transmitted to the power transmission coil 16 based on the voltage detected by the voltage detection circuit 14 and the current detected by the current detection circuit 15.

In addition, the computation unit 221 calculates received power of the power reception coil 31 based on communication data received by the power transmission coil 16 from the power reception coil 31.

Further, the computation unit 221 calculates a ratio of received power Rp(t) to transmitted power Pout(t), that is, efficiency E(t) (= Rp(t)/Pout(t)), the received power Rp(t) and the transmitted power Pout(t) being calculated at the same time t. The computation unit 221 may calculate a difference value (Pout(t) - Rp(t)) between the transmitted power Pout(t) and the received power Rp(t), which are calculated at the same time t.

The computation result comparison unit 222 compares the calculated efficiency E(t) with a preset threshold Eth. In addition, the computation result comparison unit 222 instructs the DC-DC converter 12 and the bridge circuit 13 to start and end charging. In addition, the computation result comparison unit 222 instructs the DC-DC converter 12 and the bridge circuit 13 to continue charging with normal power or continue charging with limited power. Further, the computation result comparison unit 222 instructs the power transmission coil position control unit 224 to move the position of the power transmission coil 16.

The computation result storage unit 223 sequentially updates and stores a maximum value of the efficiency E(t) calculated by the computation unit 221.

The power transmission coil position control unit 224 instructs the movement mechanism 17 to move the position of the power transmission coil 16, based on the current position of the power reception coil 31 detected by the power reception coil position detection circuit 20 and an instruction to move the position of the power transmission coil 16 by the computation result comparison unit 222.

### Positional Relationship between Power Transmission Coil and Power Reception Coil

Next, transmission efficiency according to a positional relationship between the power transmission coil 16 and the power reception coil 31 will be described. For example, the transmission efficiency decreases by 10% or more in a case where the power reception coil 31 is misaligned with the power transmission coil 16 by 6 mm or more. Since it is easy to determine a 10% decrease in transmission efficiency, it is also easy to determine a misalignment of 6 mm. Meanwhile, for example, according to the MPP standard, the charging device 10 may switch from the high-power charging to the low-power charging when a misalignment of 2 mm or more occurs during the high-power charging. A decrease in transmission efficiency at this time is about 1%.

Here, in a case where the power received by the terminal device 30 is 15 W, the transmission efficiency of 1% corresponds to 150 mW and thus falls within a normal power variation range. Therefore, in a case where misalignment determination between the power transmission coil 16 and the power reception coil 31 is performed simply based on the transmission efficiency for the received power of the terminal device 30, the charging device 10 cannot continue the high-power charging. Therefore, the charging device 10 of the present embodiment performs determination of the misalignment between the power transmission coil 16 and the power reception coil 31 according to a value of an operating voltage of the charging device 10. Specifically, the charging device 10 sets a reference voltage of the charging device 10 for the misalignment determination, and compares a relative value of the operating voltage of the power transmission coil 16 with the reference voltage to determine the misalignment.

In the terminal device 30, the received power decreases when the misalignment between the power transmission coil 16 and the power reception coil 31 occurs. Therefore, the terminal device 30 requests the charging device 10 to increase the transmitted power in order to return to the original high power. At this time, in the case of slight misalignment, the transmission efficiency hardly changes, but the operating voltage of the charging device 10 significantly increases.

Therefore, the charging device 10 determines that there is a misalignment if the received power of the terminal device 30 does not increase before and after an increase in operating voltage of the power transmission coil 16. In addition, the charging device 10 determines that there is an increase in charging power if the received power of the terminal device 30 increases before and after an increase in operating voltage of the power transmission coil 16. Further, before and after an increase in operating voltage of the power transmission coil 16, if the received power is stable (for example, contracted power has been reached) before the operating voltage is changed, the charging device 10 immediately determines that the subsequent increase in operating voltage indicates a misalignment. Hereinafter, details of processing performed by the charging device 10 will be described.

### Functional Configuration

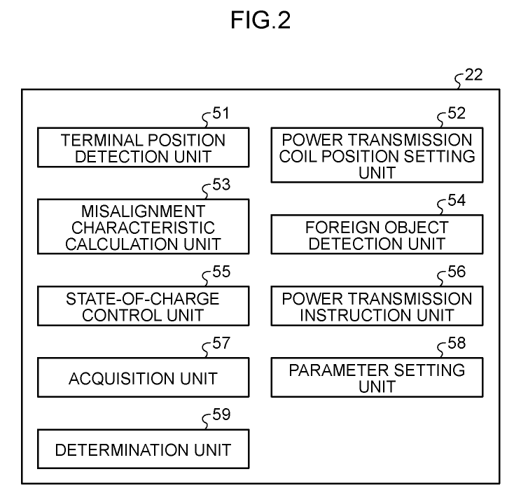

FIG. 2 is a block diagram illustrating an example of a functional configuration of the control unit 22 according to the embodiment. The control unit 22 includes a terminal position detection unit 51, a power transmission coil position setting unit 52, a misalignment characteristic calculation unit 53, a foreign object detection unit 54, a state-of-charge control unit 55, a power transmission instruction unit 56, an acquisition unit 57, a parameter setting unit 58, and a determination unit 59. The functions of the control unit 22 are not limited thereto.

When the terminal device 30 is placed on the charging stand 19, the terminal position detection unit 51 detects a position of the terminal device 30.

The power transmission coil position setting unit 52 sets a position of the power transmission coil 16 to a position facing the power reception coil 31 based on the position of the power reception coil 31 detected by the power reception coil position detection circuit 20. Then, the power transmission coil 16 is moved by the movement mechanism 17 to the position set by the power transmission coil position setting unit 52, and various authentications are performed between the charging device 10 and the terminal device 30.

The power transmission coil position setting unit 52 determines whether or not to use a misalignment characteristic. Moreover, in a case where it is determined to use the misalignment characteristic, the power transmission coil position setting unit 52 performs setting such that the power transmission coil 16 is moved to a predetermined position in order to calculate the misalignment characteristic after detecting the position of the terminal device 30, and performs setting such that the power transmission coil 16 is moved to a position where there is no misalignment between the power transmission coil 16 and the power reception coil 31 after the misalignment characteristic calculation unit 53 performs PING transmission/SIG reception.

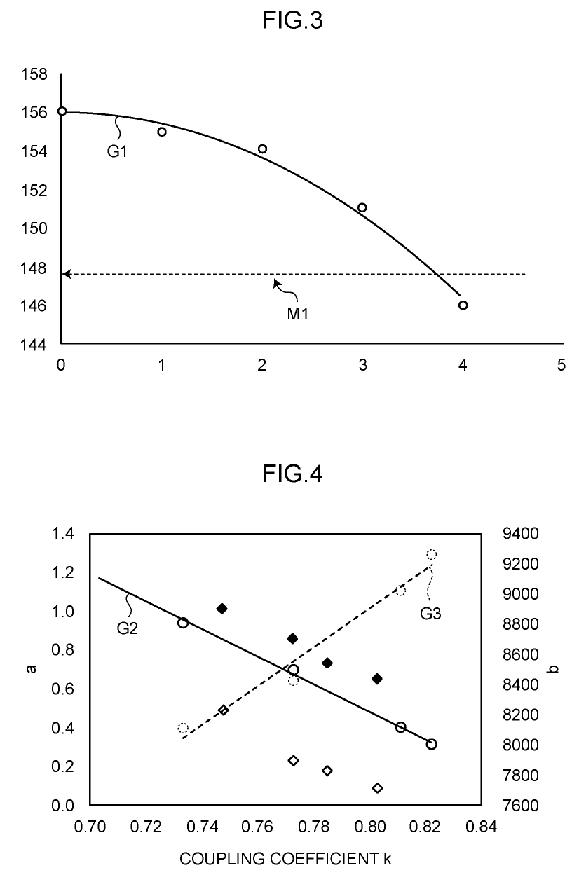

The misalignment characteristic calculation unit 53 calculates the misalignment characteristic. Specifically, the misalignment characteristic calculation unit 53 performs the PING transmission/SIG reception in the power transmission coil 16 moved to the predetermined position set by the power transmission coil position setting unit 52 after detecting the position of the terminal device 30, and calculates the misalignment characteristic. Here, the misalignment characteristic indicates a ratio of a change of the operating voltage of the charging device 10 with respect to a misalignment amount when the terminal device 30 is misaligned, and is a limit value of the operating voltage corresponding to an allowable misalignment amount. The misalignment characteristic will be described with reference to FIGS. 3 and 4.

FIGS. 3 and 4 are schematic diagrams for describing the misalignment characteristic according to the embodiment. In FIG. 3, a horizontal axis represents a misalignment amount (millimeter: mm) between the power transmission coil 16 and the power reception coil 31, and a vertical axis represents a signal strength value (SS value) received in a SIG packet. As described above, the power transmission coil position setting unit 52 performs setting such that the power transmission coil 16 is moved to the predetermined position in order to calculate the misalignment characteristic after detecting the position of the terminal device 30, and then performs the PING transmission/SIG reception. Here, the predetermined position is set to 4 mm as the misalignment amount to be detected.

As illustrated in FIG. 3, the SS value in a case where the misalignment amount is 4 mm is 146. Further, the SS value after the power transmission coil 16 moves as indicated by an arrow M1, that is, the SS value in a case where the misalignment amount is 0 mm, is 156. An SS ratio in a case where the misalignment amount is 4 mm is 94 (= 146/156)%.

The misalignment characteristic calculation unit 53 determines a first estimation equation fv(x) = a * x + b for estimating the reference voltage for a charging start position, that is, a power-voltage characteristic without misalignment. Here, coefficients a and b are determined using, for example, the least squares method, a = 0.651, and b = 7718. That is, the misalignment characteristic calculation unit 53 determines the first estimation equation fv(x) = 0.651 * x + 7718. Note that x (watt: W) in the first estimation equation is a value into which the received power is substituted. Note that the coefficients a and b are not limited thereto, and are determined according to the charging device 10.

Subsequently, the misalignment characteristic calculation unit 53 derives, by using the first estimation equation, a second estimation equation for estimating the limit value of the operating voltage of the charging device 10, which corresponds to the misalignment characteristic. The second estimation equation is, for example, fvk(x) = a(k) * x + b(k). Here, a coupling coefficient k is calculated from a relational expression between the coefficient a and the coupling coefficient k and a relational expression between the coefficient b and the coupling coefficient k. The coupling coefficient k indicates the degree of inductive coupling between the power transmission coil 16 and the power reception coil 31, and has a value of 0 or more and 1 or less.

In FIG. 4, a horizontal axis represents the coupling coefficient, a first vertical axis represents the coefficient a, and a second vertical axis represents the coefficient b. Here, the relational expression between the coefficient a and the coupling coefficient k is expressed by a(k) = -7.0757 * k + 6.1412 and indicated by a graph G2 in FIG. 4. The relational expression between the coefficient b and the coupling coefficient k is expressed by b(k) = 12819 * k - 1353, and indicated by a graph G3.

Here, when the coefficient a determined by the first estimation equation is substituted into a(k) using the relational expression between the coefficient a and the coupling coefficient k, 0.651 = -7.0757 * k + 6.1412, and the coupling coefficient k = 0.78. In addition, since the SS ratio is 94% in a case where the misalignment amount is 4 mm, the coupling coefficient k is k = 0.78 * 0.94 = 0.73.

The coefficient a(k) of the second estimation equation when the coupling coefficient becomes 94% is a(k) = -7.0757 * 0.73 + 6.1412 = 0.976. The coefficient b(k) of the second estimation equation is b(k) = 12819 * 0.73 - 1353 = 8005. As a result, the misalignment characteristic calculation unit 53 derives the second estimation equation fvk(x) = 0.976 * x + 8005. The second estimation equation can estimate the limit value of the operating voltage of the charging device 10 by substituting the received power into x.

Returning to FIG. 2, the description continues. The misalignment characteristic calculation unit 53 determines whether or not there is a required amount of data for using the first estimation equation. Here, the required amount of data is the number of data when the acquisition unit 57 described below acquires the operating voltage of the charging device 10 and the received power of the terminal device 30. In a case where there is a required amount of data for using the first estimation equation, the misalignment characteristic calculation unit 53 derives the first estimation equation by using the operating voltage of the charging device 10 and the received power of the terminal device 30, which are acquired by the acquisition unit 57.

The misalignment characteristic calculation unit 53 determines whether or not to apply the calculated misalignment characteristic. Here, when it is determined not to apply the calculated misalignment characteristic, the misalignment characteristic calculation unit 53 substitutes the received power of the terminal device 30 acquired by the acquisition unit 57 into x in the first estimation equation, and calculates the reference voltage of the charging device 10. Hereinafter, in the present specification, in a case where the misalignment characteristic is applied as appropriate, the reference voltage of the charging device 10 calculated based on the limit value of the operating voltage of the charging device 10 when the PING transmission/SIG reception is performed in the power transmission coil 16 moved to the predetermined position set by the power transmission coil position setting unit 52 after the position of the terminal device 30 is detected is referred to as a first reference voltage, and in a case where the misalignment characteristic is not applied, the reference voltage of the charging device 10 calculated using the first estimation equation is referred to as a second reference voltage.

On the other hand, when it is determined to apply the calculated misalignment characteristic, the misalignment characteristic calculation unit 53 calculates the coupling coefficient k by using the graph G1 and the graph G2 illustrated in FIG. 4 based on the data obtained by the acquisition unit 57 acquiring the operating voltage of the charging device 10 and the received power of the terminal device 30, and determines the coefficient a(k) and the coefficient b(k). Further, the misalignment characteristic calculation unit 53 calculates the limit value of the operating voltage of the charging device 10 from the second estimation equation determined again.

The foreign object detection unit 54 detects whether or not there is foreign object between the power transmission coil 16 and the power reception coil 31 based on a coupling state between the power transmission coil 16 and the power reception coil 31 when the power reception coil 31 is placed at a position where the power reception coil 31 is not misaligned with the power transmission coil 16 in a state where the charging device 10 does not perform charging. Here, the foreign object is a conductive object such as a metal piece. A foreign object is, for example, an object that causes a current to flow therethrough and generates heat therein when the wireless charging is performed. That is, the foreign object is an object that may cause ignition in the wireless charging. In addition, the foreign object is an object that causes a current to flow therethrough and causes power loss when the wireless charging is performed.

When the foreign object detection unit 54 determines that there is a foreign object between the power transmission coil 16 and the power reception coil 31, the state-of-charge control unit 55 suppresses power supplied to the power transmission coil 16. When it is determined that there is a foreign object between the power transmission coil 16 and the power reception coil 31, the state-of-charge control unit 55 may stop the power transmitted to the power transmission coil 16. At this time, the charging device 10 may notify that there is a possibility that a foreign object is inserted by using an indicator, a monitor, a buzzer, a speaker, or the like (not illustrated in FIG. 1). Moreover, in a case where the terminal device 30 complies with the MPP standard, the charging device 10 may perform CLOAK processing on the terminal device 30.

The state-of-charge control unit 55 controls at least one of the stop of the power transmitted to the power transmission coil 16 and the CLOAK processing after the determination unit 59 described below determines that there is a misalignment between the power transmission coil 16 and the power reception coil 31. In addition, after stopping the power transmitted to the power transmission coil 16 or performing the CLOAK processing, the state-of-charge control unit 55, the state-of-charge control unit 55 controls the power transmission instruction unit 56 to resume the charging of the terminal device 30 after the position of the power reception coil 31 is detected by the power reception coil position detection circuit 20, and the power transmission coil 16 is moved to the position set by the power transmission coil position setting unit 52 by the movement mechanism 17.

In addition, the state-of-charge control unit 55 controls the power transmission instruction unit 56 to start the charging of the terminal device 30. Specifically, when the foreign object detection unit 54 determines that there is no foreign object between the power transmission coil 16 and the power reception coil 31, the state-of-charge control unit 55 controls the power transmission instruction unit 56 to start the charging of the terminal device 30. After the foreign object detection unit 54 determines that there is no foreign object between the power transmission coil 16 and the power reception coil 31 and suppresses the power supplied to the power transmission coil 16, the state-of-charge control unit 55 controls the power transmission instruction unit 56 to start the charging of the terminal device 30.

Further, the state-of-charge control unit 55 determines whether or not the terminal device 30 is in a fully charged state. Specifically, the state-of-charge control unit 55 determines that the terminal device 30 is in the fully charged state in a case where a packet called end power transfer (EPT) is received from the terminal device 30, a case where an average value of a packet, which notifies of the received power and is called a received power packet (RP), during a given period is extremely low, or the like. When it is determined that the terminal device 30 is in the fully charged state, the state-of-charge control unit 55 stops the charging.

The power transmission instruction unit 56 controls the DC-DC converter 12 and the bridge circuit 13 based on an instruction from the state-of-charge control unit 55. As a result, the power is supplied to the power transmission coil 16. Specifically, the power transmission instruction unit 56 instructs the DC-DC converter 12 and the bridge circuit 13 to perform energization to generate the magnetic flux in the power transmission coil 16, thereby causing the power transmission coil 16 to transmit the power. The magnetic flux generated by the power transmission coil 16 generates the induced electromotive force in the power reception coil 31, so that the terminal device 30 is charged.

The acquisition unit 57 acquires the operating voltage of the charging device 10 and the received power of the terminal device 30. Specifically, at time t, the acquisition unit 57 periodically acquires the DC voltage stepped up or down by the DC-DC converter 12, which is detected by the voltage detection circuit 14.

For example, the acquisition unit 57 acquires, from the terminal device 30, a magnitude of the received power Rp(t) received by the power reception coil 31 at time t. In addition, for example, the acquisition unit 57 receives information including the received power Rp(t), a received power target value (control error packet (CEP)), and the like transmitted from the terminal device 30 by packet communication. Then, the acquisition unit 57 demodulates the received information to acquire the received power Rp(t).

Further, the acquisition unit 57 determines whether or not the received power of the terminal device 30 is stable. Here, a case where the received power of the terminal device 30 is stable means that a change amount of the received power is in a given range in a state where the power is constant at least in a short period of time. Here, the given range means that, for example, an absolute value of a packet that instructs the CEP from the terminal device 30 is 1 or less. The given range is not limited thereto. The given range includes, for example, a range in which the received power has already reached the contract power.

Then, the acquisition unit 57 determines whether or not a voltage difference indicating a difference between the operating voltage of the charging device 10 and the reference voltage of the charging device 10 is equal to or more than a voltage threshold. Here, for example, an operating voltage Vout1 when there is no misalignment and an operating voltage Vout2 corresponding to a misalignment amount for which misalignment determination is to be performed are set. A measurement value of a standard machine/actual machine or a value calculated from a simulation model or the like is set in advance such that the voltage threshold becomes (Vout2 - Vout1), and is stored in the storage unit.

In addition, the acquisition unit 57 determines whether or not there is an increase in received power of the terminal device 30. In one example, when a difference between the received power of the terminal device 30 and reference received power of the terminal device 30 is within a given range, the acquisition unit 57 determines that there is no increase in received power of the terminal device 30.

Further, the acquisition unit 57 determines whether or not there is a decrease in received power of the terminal device 30. For example, in a case where it is determined that the received power of the terminal device 30 is not stable and it is determined that the change amount of the received power is less than the predetermined threshold, the acquisition unit 57 determines that there is a decrease in received power of the terminal device 30. Here, the predetermined threshold is a threshold for determining a decrease in power. The predetermined threshold is set based on a power decrease amount when a misalignment whose misalignment amount is equal to or more than the misalignment amount for which misalignment determination is to be performed, in a state where the operating voltage is not changed.

Then, the acquisition unit 57 determines whether or not the voltage difference indicating the difference between the operating voltage of the charging device 10 and the reference voltage of the charging device 10 is equivalent to or more than a change amount of the operating voltage when the power is stable. Specifically, in a case where it is determined that there is a decrease in received power of the terminal device 30, and the voltage difference indicating the difference between the operating voltage of the charging device 10 and the reference voltage of the charging device 10 is equal to or more than a voltage value at which the change amount of the received power is in the given range, the acquisition unit 57 determines that the voltage difference indicating the difference between the operating voltage of the charging device 10 and the reference voltage of the charging device 10 is equivalent to or more than the change amount of the operating voltage when the power is stable.

When the state-of-charge control unit 55 controls the power transmission instruction unit 56 to start the wireless charging for the terminal device 30, the parameter setting unit 58 initializes a parameter for misalignment determination. Here, the parameter includes the reference voltage of the charging device 10 and the reference received power of the terminal device 30, which serve as references for misalignment determination.

In addition, the parameter setting unit 58 sets the parameter after the wireless charging is started. Specifically, the parameter setting unit 58 determines whether or not the reference voltage of the charging device 10 has not yet been determined after the wireless charging is started. In addition, the parameter setting unit 58 sets the parameter in a case where the reference voltage of the charging device 10 has not yet been determined after the wireless charging is started. For example, the parameter setting unit 58 performs setting such that (reference voltage of charging device 10) = (operating voltage of charging device 10) and (reference received power of terminal device 30) = (received power of terminal device 30) in a case where the reference voltage of the charging device 10 has not yet been determined in a state where the received power of the terminal device 30 is stable after the wireless charging is started.

Further, the parameter setting unit 58 updates the parameter. Specifically, the parameter setting unit 58 updates the parameter in a case where the voltage difference indicating the difference between the operating voltage of the charging device 10 and the reference voltage of the charging device 10 is less than the voltage threshold after the wireless charging is started. In addition, the parameter setting unit 58 updates the parameter in a case where the voltage difference indicating the difference between the operating voltage of the charging device 10 and the reference voltage of the charging device 10 is equal to or more than the voltage threshold, and the received power of the terminal device 30 is not stable, after the wireless charging is started.

Further, in a case where the determination unit 59 determines that the voltage difference is less than the voltage threshold, the parameter setting unit 58 updates the parameter. Then, the parameter setting unit 58 updates the parameter in a case where the determination unit 59 determines that the operating voltage of the charging device 10 is lower than the limit value of the operating voltage of the charging device 10, which is calculated from the second estimation equation, after the wireless charging is started.

The parameter setting unit 58 performs setting such that (reference voltage of charging device 10) = (operating voltage of charging device 10) and (reference received power of terminal device 30) = (received power of terminal device 30) in a case where the operating voltage of the charging device 10 is higher than (reference voltage + first change amount), and the received power is higher than (reference received power + second change amount). Further, the parameter setting unit 58 performs setting such that (reference voltage of charging device 10) = (operating voltage of charging device 10) and (reference received power of terminal device 30) = (received power of terminal device 30) in a case where the operating voltage of the charging device 10 is lower than (reference voltage - first change amount), and the received power is lower than (reference received power - second change amount).

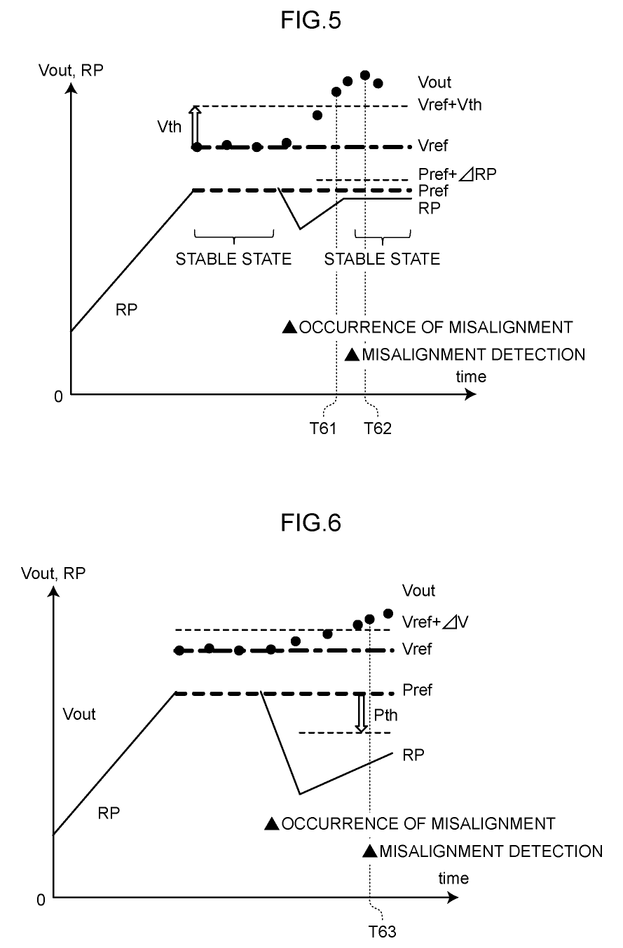

The determination unit 59 performs determination of the misalignment between the power transmission coil 16 and the power reception coil 31 according to the voltage difference indicating the difference between the operating voltage of the charging device 10 and the reference voltage of the charging device. Specifically, the determination unit 59 performs determination of the misalignment between the power transmission coil 16 and the power reception coil 31 in a case where the received power is stable. When the acquisition unit 57 determines that the voltage difference indicating the difference between the operating voltage of the charging device 10 and the reference voltage of the charging device 10 is equal to or more than the voltage threshold in a state where the received power is stable, the determination unit 59 determines that there is a misalignment between the power transmission coil 16 and the power reception coil 31. Further, when the acquisition unit 57 determines that the voltage difference indicating the difference between the operating voltage of the charging device 10 and the reference voltage of the charging device 10 is equal to or more than the voltage threshold in a state where the received power is stable and determines that there is no increase in received power of the terminal device 30, the determination unit 59 determines that there is a misalignment between the power transmission coil 16 and the power reception coil 31. Here, details of the determination made by the determination unit 59 that there is a misalignment between the power transmission coil 16 and the power reception coil 31 will be described with reference to FIG. 5.

FIG. 5 is a schematic diagram for describing a state of the misalignment between the power transmission coil 16 and the power reception coil 31 according to the embodiment. FIG. 5 is a graph in which a horizontal axis represents time and a vertical axis represents an operating voltage Vout and received power RP of the charging device 10. In addition, FIG. 5 illustrates a reference voltage Vref for misalignment determination, a voltage threshold Vth, a reference received power Pref when the reference voltage Vref is determined, and a change amount ΔRP of the received power when the power is stable.

As illustrated in FIG. 5, when a misalignment occurs after the received power RP becomes stable, the operating voltage Vout of the charging device 10 increases, and the received power RP decreases and is unstable. In addition, at a time point T61 immediately before misalignment detection, the operating voltage Vout of the charging device 10 increases, and the received power RP increases and is unstable. At a time point T62 immediately after misalignment detection, the operating voltage Vout of the charging device 10 increases, and the received power RP is constant and stable. In addition, a difference between the operating voltage Vout of the charging device 10 and the reference voltage Vref of the charging device 10 is equal to or more than the voltage threshold Vth before and after misalignment detection.

Returning to FIG. 2, the description continues. When it is determined that the received power RP has decreased and the voltage difference indicating the difference between the operating voltage Vout of the charging device 10 and the reference voltage Vref of the charging device 10 is equivalent to or more than the change amount of the operating voltage when the power is stable, the determination unit 59 determines that there is a misalignment between the power transmission coil 16 and the power reception coil 31. Here, details of the determination made by the determination unit 59 that there is a misalignment between the power transmission coil 16 and the power reception coil 31 will be described with reference to FIG. 6.

FIG. 6 is a schematic diagram for describing details of the misalignment between the power transmission coil 16 and the power reception coil 31 according to the embodiment. FIG. 6 is a graph in which a horizontal axis represents time and a vertical axis represents the operating voltage Vout and the received power RP of the charging device 10. In addition, FIG. 6 illustrates the reference voltage Vref for misalignment determination, a change amount ΔV of the operating voltage Vout when the power is stable, the reference received power Pref when the reference voltage Vref is determined, and a threshold Pth for determination of a decrease in power.

As illustrated in FIG. 6, the operating voltage Vout of the charging device 10 increases and the received power RP decreases when the misalignment occurs. However, the received power RP is higher than the threshold Pth for determination of a decrease in power, and thus, it can be said that the received power is constant. In addition, at a time point T63 at which the misalignment is detected, the operating voltage Vout of the charging device 10 increases and the received power RP increases. However, the received power RP is lower than the threshold Pth for determination of a decrease in power, and thus, it can be said that the received power has decreased. Before and after misalignment detection, the difference between the operating voltage Vout of the charging device 10 and the reference voltage Vref of the charging device 10 is equivalent to or more than the change amount ΔV of the operating voltage Vout when the power is stable. Therefore, the determination unit 59 determines that the misalignment has occurred in a case where the voltage difference indicating the difference between the operating voltage Vout of the charging device 10 and the reference voltage Vref of the charging device 10 is equal to or more than a voltage value at which a change amount of the received power RP is in the given range in a state where the received power RP has decreased.

Returning to FIG. 2, the description continues. When it is determined that the received power RP has increased, the determination unit 59 determines whether or not there is a required amount of data for deriving the first estimation equation. In addition, when the determination unit 59 determines that the received power RP has decreased and the voltage difference indicating the difference between the operating voltage Vout of the charging device 10 and the reference voltage Vref of the charging device 10 is less than the change amount of the operating voltage when the power is stable, the misalignment characteristic calculation unit 53 determines whether or not there is a required amount of data for deriving the first estimation equation fv(x) = a * x + b.

Then, when it is determined that the voltage difference indicating the difference between the operating voltage of the charging device 10 acquired by the acquisition unit 57 and the reference voltage of the charging device 10 calculated by the misalignment characteristic calculation unit 53 using the first estimation equation is equal to or more than the voltage threshold, the determination unit 59 determines that there is a misalignment between the power transmission coil 16 and the power reception coil 31.

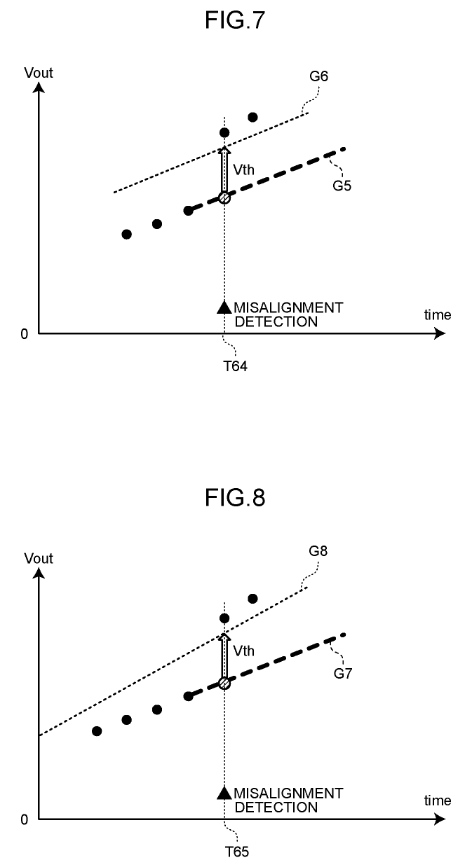

FIG. 7 is a schematic diagram for describing details of the misalignment between the power transmission coil 16 and the power reception coil 31 according to the embodiment. FIG. 7 is a graph in which a horizontal axis represents time and a vertical axis represents the operating voltage Vout of the charging device 10. Here, the received power RP of the terminal device 30 acquired by the acquisition unit 57 is substituted into the first estimation equation fv(x) = a * x + b, and a transition of the reference voltage Vref of the charging device 10 is indicated by a graph G5. In addition, a result obtained by adding the voltage threshold Vth to the graph G5 is indicated by a graph G6. Here, it is assumed that the voltage threshold Vth is a fixed value.

As illustrated in FIG. 7, at a time point T64 at which the misalignment is detected, the operating voltage Vout of the charging device 10 is above the graph G6. That is, the difference from the reference voltage of the charging device 10 calculated using the first estimation equation is equal to or more than the voltage threshold.

FIG. 8 is a schematic diagram for describing details of the misalignment between the power transmission coil 16 and the power reception coil 31 according to the embodiment. FIG. 8 is a graph in which a horizontal axis represents time and a vertical axis represents the operating voltage Vout of the charging device 10. Here, the received power RP of the terminal device 30 acquired by the acquisition unit 57 is substituted into the first estimation equation fv(x) = a * x + b, and a transition of the reference voltage Vref of the charging device 10 is indicated by a graph G7. In addition, a result obtained by adding the voltage threshold Vth to the graph G7 is indicated by a graph G8. Here, it is assumed that the voltage threshold Vth is an associated value which is associated with the received power.

As illustrated in FIG. 8, at a time point T65 at which the misalignment is detected, the operating voltage Vout of the charging device 10 is above the graph G8. That is, the voltage difference indicating the difference from the reference voltage of the charging device 10 calculated using the first estimation equation is equal to or more than the voltage threshold.

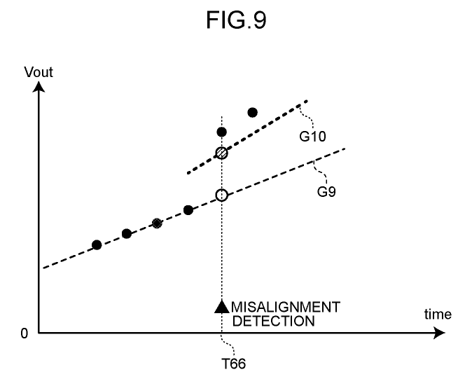

Returning to FIG. 2, the description continues. When it is determined that the operating voltage of the charging device 10 acquired by the acquisition unit 57 is equal to or higher than the limit value of the operating voltage of the charging device 10 calculated from the second estimation equation determined again by the misalignment characteristic calculation unit 53, the determination unit 59 determines that there is a misalignment between the power transmission coil 16 and the power reception coil 31. Here, details of the determination made by the determination unit 59 that there is a misalignment between the power transmission coil 16 and the power reception coil 31 will be described with reference to FIG. 9.

FIG. 9 is a schematic diagram for describing details of the misalignment between the power transmission coil 16 and the power reception coil 31 according to the embodiment. FIG. 9 is a graph in which a horizontal axis represents time and a vertical axis represents the operating voltage Vout of the charging device 10. Here, the first estimation equation is indicated by a graph G9. In addition, by using the misalignment characteristic, the received power RP of the terminal device 30 acquired by the acquisition unit 57 is substituted into fvk(x) = a(k) * x + b(k), and a transition of the limit value of the operating voltage Vout of the charging device 10, which corresponds to the misalignment characteristic, is indicated by a graph G10.

As illustrated in FIG. 9, at a time point T66 at which the misalignment is detected, the operating voltage Vout of the charging device 10 is above the graph G10. That is, the operating voltage of the charging device 10 is equal to or higher than the limit value of the operating voltage of the charging device 10 calculated from the second estimation equation determined again by the misalignment characteristic calculation unit 53.

In addition, in the present embodiment, the charging device 10 performs misalignment determination after starting the wireless charging. However, it is desirable to perform the foreign object detection processing with priority when the foreign object detection circuit 21 detects that there is a metal foreign object between the power transmission coil 16 and the power reception coil 31.

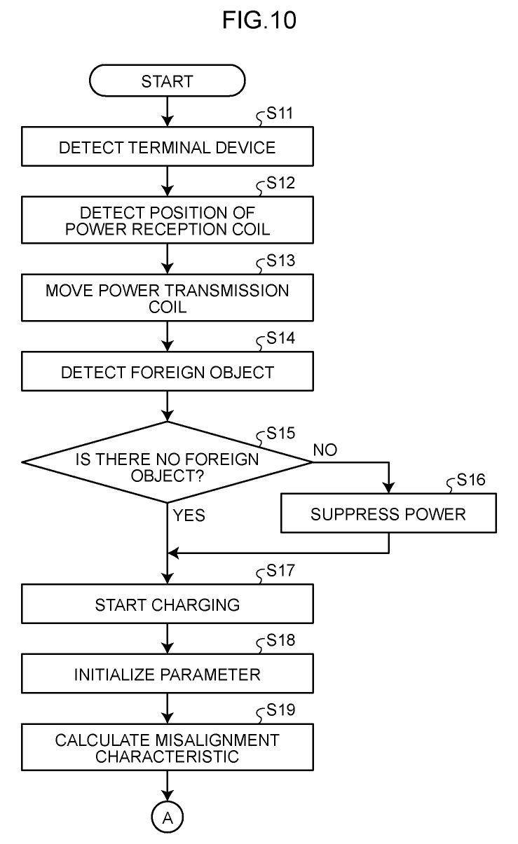

FIG. 10 is a flowchart illustrating an example of a procedure of processing performed by the charging device 10 according to the embodiment. Details of processing until the charging device 10 starts the wireless charging are described with reference to FIG. 10.

When the terminal device 30 is placed on the charging stand 19, the terminal position detection unit 51 detects the position of the terminal device 30 (step S11). Subsequently, the power reception coil position detection circuit 20 detects the position of the power reception coil 31 (step S12). Then, the power transmission coil position setting unit 52 sets the position of the power transmission coil 16 to a position facing the power reception coil 31 based on the position of the power reception coil 31 detected by the power reception coil position detection circuit 20. Then, the power transmission coil 16 is moved to the position set by the power transmission coil position setting unit 52 by the movement mechanism 17 (step S13).

Subsequently, the foreign object detection circuit 21 performs the foreign object detection processing (step S14). Then, the foreign object detection unit 54 detects whether or not there is a foreign object between the power transmission coil 16 and the power reception coil 31 based on the coupling state between the power transmission coil 16 and the power reception coil 31 when the power reception coil 31 is placed at a position where the power reception coil 31 is not misaligned with the power transmission coil 16 in a state where the charging device 10 does not perform charging (step S15). Here, in a case where the foreign object detection unit 54 detects that there is no foreign object between the power transmission coil 16 and the power reception coil 31 (step S15: Yes), the processing proceeds to step S17. On the other hand, in a case where the foreign object detection unit 54 detects that there is a foreign object between the power transmission coil 16 and the power reception coil 31 (step S15: No), the processing proceeds to step S16.

In step S16, the state-of-charge control unit 55 suppresses the power supplied to the power transmission coil 16 (step S16). In step S17, the state-of-charge control unit 55 controls the power transmission instruction unit 56 to start the charging of the terminal device 30 (step S17). Subsequently, when the state-of-charge control unit 55 controls the power transmission instruction unit 56 to start the charging of the terminal device 30, the parameter setting unit 58 initializes the parameter for misalignment determination (step S18). Then, the misalignment characteristic calculation unit 53 calculates the misalignment characteristic (step S19). Upon completion of the processing of step S19, the charging device 10 proceeds to Processing A.

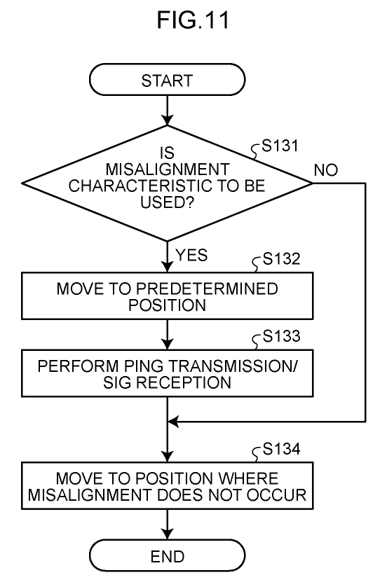

FIG. 11 is a flowchart illustrating an example of a procedure of processing performed by the charging device 10 according to the embodiment. More details of the processing of step S13 for performing step S19 illustrated in FIG. 10 are described with reference to FIG. 11.

The power transmission coil position setting unit 52 determines whether or not to use the misalignment characteristic (step S131). Here, in a case where the power transmission coil position setting unit 52 determines not to use the misalignment characteristic (step S131: No), the charging device 10 proceeds to step S134. On the other hand, in a case where the power transmission coil position setting unit 52 determines to use the misalignment characteristic (step S131: Yes), the charging device 10 proceeds to step S132. In step S132, the power transmission coil position setting unit 52 performs setting such that the power transmission coil 16 is moved to a predetermined position in order to calculate the misalignment characteristic after detecting the position of the terminal device 30 (step S132).

Subsequently, the misalignment characteristic calculation unit 53 performs the PING transmission/SIG reception (step S133). Then, the power transmission coil position setting unit 52 performs setting such that the power transmission coil 16 is moved to a position where the power transmission coil 16 is not misaligned with the power reception coil 31 (step S134). The charging device 10 can perform step S19 illustrated in FIG. 10 by performing the processing from step S131 to step S134.

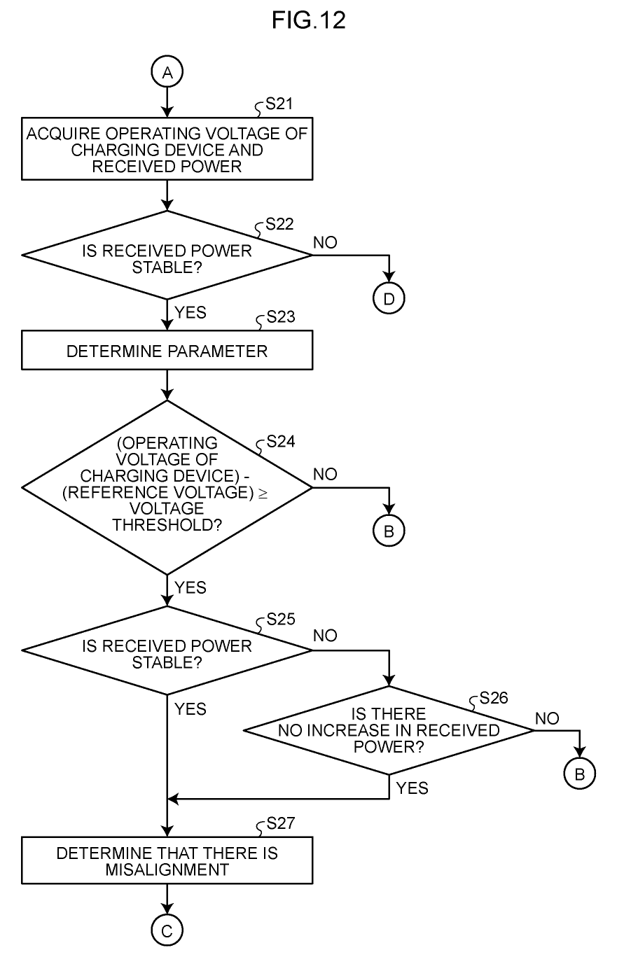

FIG. 12 is a flowchart illustrating an example of a procedure of processing performed by the charging device 10 according to the embodiment. FIG. 12 illustrates a content corresponding to Processing A illustrated in FIG. 10. Details of processing until the misalignment between the power transmission coil 16 and the power reception coil 31 is determined after the charging device 10 starts the wireless charging are described with reference to FIG. 12.

The acquisition unit 57 acquires the operating voltage of the charging device 10 and the received power of the terminal device 30 (step S21). Subsequently, the acquisition unit 57 determines whether or not the received power of the terminal device 30 is stable (step S22). Here, in a case where the acquisition unit 57 determines that the received power of the terminal device 30 is not stable (step S22: No), the processing proceeds to Processing D. On the other hand, in a case where the acquisition unit 57 determines that the received power of the terminal device 30 is stable (step S22: Yes), the processing proceeds to step S23. The received power of the terminal device 30 is regarded as stable in step S22 when the absolute value of the packet that instructs the CEP from the terminal device 30 is 1 or less.

In step S23, the parameter setting unit 58 sets the parameter (step S23). Subsequently, the acquisition unit 57 determines whether or not the voltage difference indicating the difference between the operating voltage of the charging device 10 and the reference voltage of the charging device 10 is equal to or more than the voltage threshold (step S24). Here, in a case where the acquisition unit 57 determines that the voltage difference indicating the difference between the operating voltage of the charging device 10 and the reference voltage of the charging device 10 is less than the voltage threshold (step S24: No), the processing proceeds to Processing B. On the other hand, in a case where the acquisition unit 57 determines that the voltage difference indicating the difference between the operating voltage of the charging device 10 and the reference voltage of the charging device 10 is equal to or more than the voltage threshold (step S24: Yes), the processing proceeds to step S25.

In step S25, the acquisition unit 57 determines whether or not the received power of the terminal device 30 is stable (step S25). Here, in a case where the acquisition unit 57 determines that the received power of the terminal device 30 is not stable (step S25: No), the processing proceeds to step S26. On the other hand, in a case where the acquisition unit 57 determines that the received power of the terminal device 30 is stable (step S25: Yes), the processing proceeds to step S27. The received power of the terminal device 30 is regarded as stable in step S25 when the received power has already reached the contract power.

In step S26, the acquisition unit 57 determines whether or not there is an increase in received power of the terminal device 30 (step S26). Here, in a case where the acquisition unit 57 determines that there is an increase in received power of the terminal device 30 (step S26: No), the processing proceeds to Processing B. On the other hand, in a case where the acquisition unit 57 determines that there is no increase in received power of the terminal device 30 (step S26: Yes), the processing proceeds to step S27. In step S27, the determination unit 59 determines that there is a misalignment between the power transmission coil 16 and the power reception coil 31 (step S27). Upon completion of the processing of step S27, the charging device 10 proceeds to Processing C.

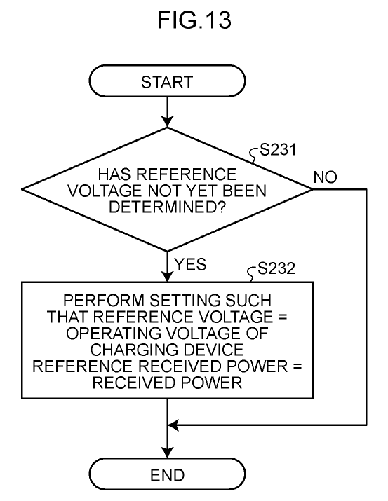

FIG. 13 is a flowchart illustrating an example of a procedure of processing performed by the charging device 10 according to the embodiment. More details of the processing of step S23 illustrated in FIG. 12 are described with reference to FIG. 13.

The parameter setting unit 58 determines whether or not the reference voltage of the charging device 10 has not yet been determined (step S231). Here, in a case where the parameter setting unit 58 determines that the reference voltage of the charging device 10 has been determined (step S231: No), the processing proceeds to step S24 illustrated in FIG. 12. On the other hand, in a case where the parameter setting unit 58 determines that the reference voltage of the charging device 10 has not yet been determined (step S231: Yes), the processing proceeds to step S232.

In step S232, the parameter setting unit 58 sets the parameter such that (reference voltage of charging device 10) = (operating voltage of charging device 10) and (reference received power of terminal device 30) = (received power of terminal device 30) (step S232). Upon completion of the processing of step S232, the charging device 10 proceeds to the processing of step S24 illustrated in FIG. 12.

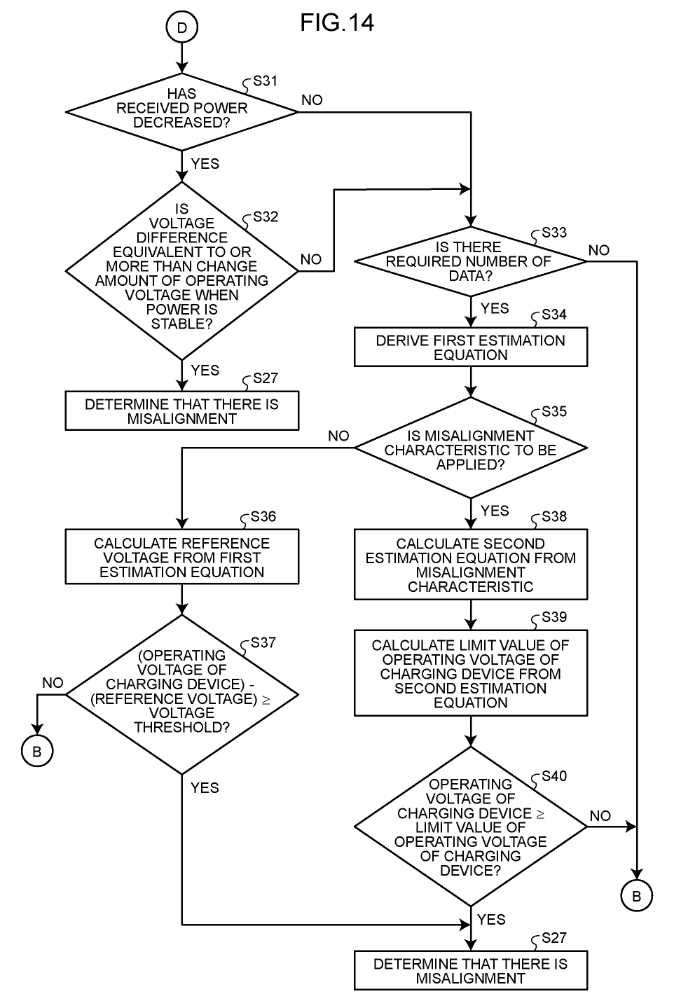

FIG. 14 is a flowchart illustrating an example of a procedure of processing performed by the charging device 10 according to the embodiment. FIG. 14 illustrates a content corresponding to Processing D illustrated in FIG. 12. The processing of step S27 illustrated in FIG. 14 is similar to the content of the processing of step S27 illustrated in FIG. 12, and thus a detailed description is omitted.

The acquisition unit 57 determines whether or not there is a decrease in received power of the terminal device 30 (step S31). Here, in a case where the acquisition unit 57 determines that there is no decrease in received power of the terminal device 30 (step S31: No), the processing proceeds to step S33. On the other hand, in a case where the acquisition unit 57 determines that there is a decrease in received power of the terminal device 30 (step S31: Yes), the processing proceeds to step S32.

In step S32, the acquisition unit 57 determines whether or not the voltage difference indicating the difference between the operating voltage of the charging device 10 and the reference voltage of the charging device 10 is equivalent to or more than the change amount of the operating voltage when the power is stable (step S32). Here, in a case where the acquisition unit 57 determines that the voltage difference indicating the difference between the operating voltage of the charging device 10 and the reference voltage of the charging device 10 is equivalent to or more than the change amount of the operating voltage when the power is stable (step S32: Yes), the processing proceeds to step S27. On the other hand, in a case where the acquisition unit 57 determines that the voltage difference indicating the difference between the operating voltage of the charging device 10 and the reference voltage of the charging device 10 is less than the change amount of the operating voltage when the power is stable (step S32: No), the processing proceeds to step S33.

In step S33, the misalignment characteristic calculation unit 53 determines whether or not there is a required amount of data for using the first estimation equation (step S33). Here, in a case where the misalignment characteristic calculation unit 53 determines that there is no required amount of data for using the first estimation equation (step S33: No), the processing proceeds to Processing B. On the other hand, in a case where the misalignment characteristic calculation unit 53 determines that there is a required amount of data for using the first estimation equation (step S33: Yes), the processing proceeds to step S34.

In step S34, the misalignment characteristic calculation unit 53 derives the first estimation equation by using the operating voltage of the charging device 10 and the received power of the terminal device 30, which are acquired by the acquisition unit 57 (step S34). Subsequently, the misalignment characteristic calculation unit 53 determines whether or not to apply the calculated misalignment characteristic (step S35). Here, in a case where the misalignment characteristic calculation unit 53 determines to apply the calculated misalignment characteristic (step S35: Yes), the processing proceeds to step S38. On the other hand, in a case where the misalignment characteristic calculation unit 53 determines not to apply the calculated misalignment characteristic (step S35: No), the processing proceeds to step S36.

In a case where it is determined not to apply the calculated misalignment characteristic in step S36, the misalignment characteristic calculation unit 53 substitutes the received power of the terminal device 30 acquired by the acquisition unit 57 into x in the first estimation equation, and calculates the reference voltage of the charging device 10 (step S36). Subsequently, the determination unit 59 determines that the voltage difference indicating the difference between the operating voltage of the charging device 10 acquired by the acquisition unit 57 and the reference voltage of the charging device 10 calculated by the misalignment characteristic calculation unit 53 using the first estimation equation is equal to or more than the voltage threshold (step S37). Here, in a case where it is determined that the voltage difference is equal to or more than the voltage threshold (step S37: Yes), the determination unit 59 proceeds to step S27. On the other hand, in a case where the determination unit 59 determines that the voltage difference is less than the voltage threshold (step S37: No), the processing proceeds to Processing B.

In step S38, the misalignment characteristic calculation unit 53 calculates the coupling coefficient k by using the graph G1 and the graph G2 illustrated in FIG. 4 based on the data obtained by the acquisition unit 57 acquiring the operating voltage of the charging device 10 and the received power of the terminal device 30, determines the coefficient a(k) and the coefficient b(k), and determines the second estimation equation again (step S38). Subsequently, the misalignment characteristic calculation unit 53 calculates the limit value of the operating voltage of the charging device 10 from the second estimation equation determined again (step S39).

Subsequently, the determination unit 59 determines whether or not the operating voltage of the charging device 10 acquired by the acquisition unit 57 is equal to or higher than the limit value of the operating voltage of the charging device 10 calculated from the second estimation equation determined again by the misalignment characteristic calculation unit 53 (step S40). Here, in a case where the determination unit 59 determines that the operating voltage of the charging device 10 is equal to or higher than the limit value of the operating voltage of the charging device 10 calculated from the second estimation equation (step S40: Yes), the processing proceeds to step S27. On the other hand, in a case where the determination unit 59 determines that the operating voltage of the charging device 10 is lower than the limit value of the operating voltage of the charging device 10 calculated from the second estimation equation (step S40: No), the processing proceeds to Processing B.

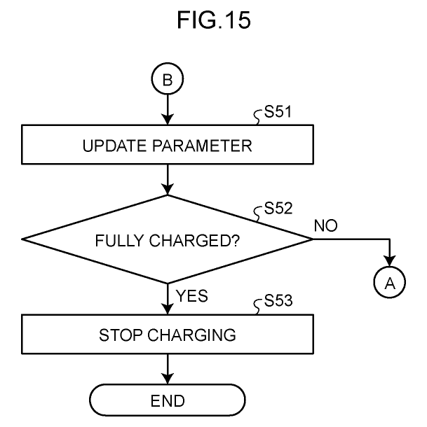

FIG. 15 is a flowchart illustrating an example of a procedure of processing performed by the charging device 10 according to the embodiment. FIG. 15 illustrates a content corresponding to Processing B illustrated in FIGS. 12 and 14.

The parameter setting unit 58 updates the parameter (step S51). Subsequently, the state-of-charge control unit 55 determines whether or not the terminal device 30 is in the fully charged state (step S52). Here, in a case where the state-of-charge control unit 55 determines that the terminal device 30 is not in the fully charged state (step S52: No), the processing proceeds to Processing A. On the other hand, in a case where the state-of-charge control unit 55 determines that the terminal device 30 is in the fully charged state (step S52: Yes), the processing proceeds to step S53.

In a case where it is determined in step S53 that the terminal device 30 is in the fully charged state, the state-of-charge control unit 55 stops the charging (step S53). Upon completion of the processing of step S53, the charging device 10 ends the wireless charging.

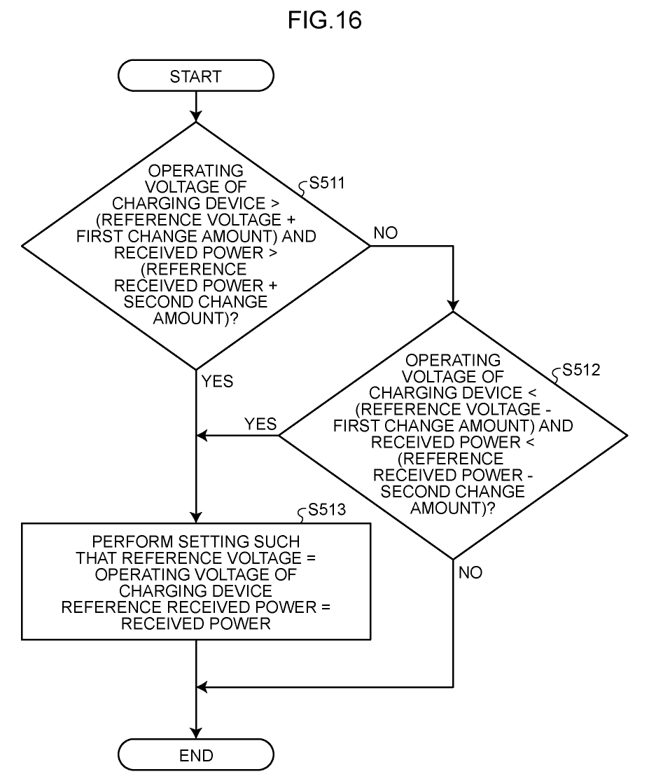

FIG. 16 is a flowchart illustrating an example of a procedure of processing performed by the charging device 10 according to the embodiment. More details of the processing of step S51 illustrated in FIG. 15 are described with reference to FIG. 16.

The parameter setting unit 58 determines whether or not the operating voltage of the charging device 10 is higher than (reference voltage + first change amount) and the received power is higher than (reference received power + second change amount) (step S511). Here, in a case where the parameter setting unit 58 determines that the condition that the operating voltage of the charging device 10 is higher than (reference voltage + first change amount) and the received power is higher than (reference received power + second change amount) is satisfied (step S511: Yes), the processing proceeds to step S513. On the other hand, in a case where the parameter setting unit 58 determines that the condition that the operating voltage of the charging device 10 is higher than (reference voltage + first change amount) and the received power is higher than (reference received power + second change amount) is not satisfied (step S511: No), the processing proceeds to step S512.

In step S512, the parameter setting unit 58 determines whether or not the operating voltage of the charging device 10 is lower than (reference voltage - first change amount) and the received power is lower than (reference received power - second change amount) (step S512). Here, in a case where it is determined that the condition that the operating voltage of the charging device 10 is lower than (reference voltage - first change amount) and the received power is lower than (reference received power - second change amount) is not satisfied (step S512: No), the parameter setting unit 58 ends the processing. On the other hand, in a case where it is determined that the operating voltage of the charging device 10 is lower than (reference voltage - first change amount) and the received power is lower than (reference received power - second change amount) (step S512: Yes), the parameter setting unit 58 proceeds to step S513.

In step S513, the parameter setting unit 58 performs setting such that (reference voltage of charging device 10) = (operating voltage of charging device 10) and (reference received power of terminal device 30) = (received power of terminal device 30) (step S513). When the processing of step S513 or the processing of step S512 (No) ends, the charging device 10 ends the processing of updating the parameter.

That is, in a case where, in a state where the received power has decreased (step S31: Yes), a second voltage difference indicating a difference between the operating voltage of the charging device 10 and the second reference voltage for misalignment determination is less than a voltage threshold indicating a difference between a first operating voltage of the charging device 10 when there is a misalignment and a second operating voltage of the charging device 10 when there is no misalignment (step S32: No), the operating voltage of the charging device 10 is higher than the sum of the second reference voltage and the first change amount, and the received power is higher than the sum of the reference received power and the second change amount (step S511: Yes), the parameter setting unit 58 sets the operating voltage as the second reference voltage and sets the received power as the reference received power (step S513). Then, in a case where the second voltage difference indicating the difference between the operating voltage of the charging device 10 and the second reference voltage is less than the voltage threshold indicating the difference between the first operating voltage of the charging device 10 when there is a misalignment and the second operating voltage of the charging device 10 when there is no misalignment (step S32: No), the operating voltage of the charging device 10 is lower than the difference between the second reference voltage and the first change amount, and the received power is lower than the difference between the reference received power and the second change amount (step S512: Yes), the parameter setting unit 58 sets the operating voltage as the second reference voltage and sets the received power as the reference received power (step S513).

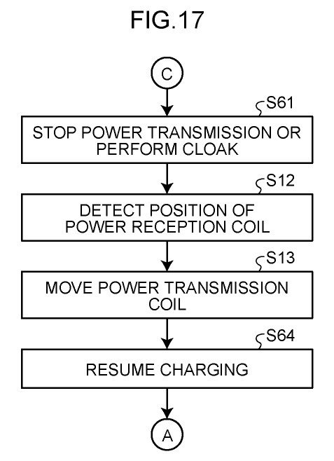

FIG. 17 is a flowchart illustrating an example of a procedure of processing performed by the charging device 10 according to the embodiment. FIG. 17 illustrates a content corresponding to Processing A illustrated in FIG. 12. That is, FIG. 17 illustrates a content related to processing after the charging device 10 performs determination of the misalignment between the power transmission coil 16 and the power reception coil 31. Steps S12 and S13 illustrated in FIG. 17 have the same contents as steps S12 and S13 illustrated in FIG. 10, and thus a description thereof is omitted.

In step S61, when the determination unit 59 described below determines that there is a misalignment between the power transmission coil 16 and the power reception coil 31, the state-of-charge control unit 55 stops the power transmitted to the power transmission coil 16 or performs the CLOAK processing (step S61).

In step S64, the state-of-charge control unit 55 controls the power transmission instruction unit 56 to resume the charging of the terminal device 30 (step S64). Upon completion of the processing of step S64, the charging device 10 proceeds to Processing A.

As described above, the charging device 10 according to one aspect of the present disclosure is a charging device that performs the wireless charging for the terminal device 30 placed on the charging stand 19, the terminal device 30 including the power reception coil 31 that receives wirelessly transmitted power. The charging device 10 includes the power transmission coil 16 that transmits the power to the terminal device 30, the acquisition unit 57 that acquires the operating voltage of the charging device 10 and the received power of the terminal device 30 after the charging device 10 starts the wireless charging for the terminal device 30, the misalignment characteristic calculation unit 53 that calculates the first reference voltage of the charging device 10, and the determination unit 59 that performs determination of the misalignment between the power transmission coil 16 and the power reception coil 31 according to a first voltage difference indicating a difference between the operating voltage of the charging device 10 and the first reference voltage.

For example, in a case where the charging device 10 detects the misalignment by using the transmission efficiency and the difference between the transmitted power and the received power, it is necessary to use the communication data transmitted from the terminal device 30. In addition, accuracy of power information included in the communication data may affect misalignment detection accuracy. Furthermore, in a state where the received power of the terminal device 30 is stable, the transmission efficiency changes according to a load state of the terminal device 30, but a voltage value of the charging device 10 increases or decreases depending on the CEP from the terminal device 30. Therefore, if determination as to whether or not a misalignment has been detected is performed according to an increase in transmitted power during a normal operation by simply monitoring a change in voltage value of the charging device 10, erroneous detection may occur.

The charging device 10 according to the present disclosure can perform determination of the misalignment between the power transmission coil 16 and the power reception coil 31 using only the voltage value of the charging device 10. Therefore, there is no influence of the communication data of the terminal device 30 or an increase in transmitted power. Accordingly, in the detection of the misalignment between the power transmission coil 16 and the power reception coil 31, the charging device 10 can detect even a slight misalignment, correct the misalignment again after the detection, and continue the high-power charging. Therefore, the charging device 10 can further increase the power efficiency in the wireless charging as compared with the related art.

Note that the above-described embodiment can be implemented by being appropriately modified in a manner of changing part of the configuration or function of each of the above-described devices. Therefore, in the following, some modified examples according to the above-described embodiment will be described as other embodiments. In the following description, points different from the above-described embodiment will be mainly described, and a detailed description of points common to the contents already described will be omitted.

### First Modified Example

The charging device 10 may perform determination of the misalignment between the power transmission coil 16 and the power reception coil 31 by using another processing in and after step S25 described above in FIG. 12.

For example, the determination unit 59 determines that there is a misalignment in a case where the first voltage difference is equal to or more than the voltage threshold indicating the difference between the first operating voltage of the charging device 10 when there is a misalignment and the second operating voltage of the charging device 10 when there is no misalignment, and the first voltage difference is equal to or more than a first threshold, in a state where the received power RP of the terminal device 30 is stable. In addition, the determination unit 59 determines that there is a misalignment in a case where the first voltage difference is equal to or more than the voltage threshold indicating the difference between the first operating voltage of the charging device 10 when there is a misalignment and the second operating voltage of the charging device 10 when there is no misalignment, and the first voltage difference is equal to or more than a second threshold, in a state where the received power RP of the terminal device 30 is stable.

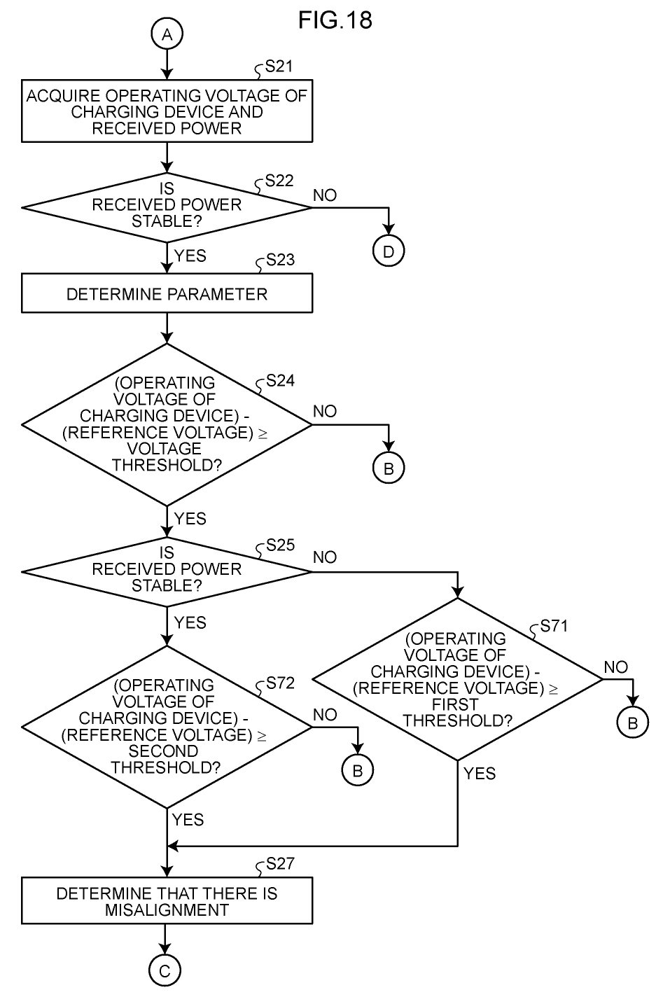

FIG. 18 is a flowchart illustrating an example of a procedure of processing performed by the charging device 10 according to a first modified example. Since the processing from step S21 to step S25 and step S27 illustrated in FIG. 18 is similar to the content of the processing from step S21 to step S25 and step S27 illustrated in FIG. 12, a description thereof will be omitted.

In step S71, the acquisition unit 57 determines whether or not the voltage difference indicating the difference between the operating voltage of the charging device 10 and the reference voltage of the charging device 10 is equal to or more than the first threshold (step S71). The first threshold is, for example, 1 V. Note that a value of the first threshold is not limited thereto. Here, in a case where the acquisition unit 57 determines that the voltage difference indicating the difference between the operating voltage of the charging device 10 and the reference voltage of the charging device 10 is equal to or more than the first threshold (step S71: Yes), the processing proceeds to step S27. On the other hand, in a case where the acquisition unit 57 determines that the voltage difference indicating the difference between the operating voltage of the charging device 10 and the reference voltage of the charging device 10 is less than the first threshold (step S71: No), the processing proceeds to Processing B.

In step S72, the acquisition unit 57 determines whether or not the voltage difference indicating the difference between the operating voltage of the charging device 10 and the reference voltage of the charging device 10 is equal to or more than the second threshold (step S72). The second threshold is, for example, equal to or less than the first threshold. Here, in a case where the acquisition unit 57 determines that the voltage difference indicating the difference between the operating voltage of the charging device 10 and the reference voltage of the charging device 10 is equal to or more than the second threshold (step S72: Yes), the processing proceeds to step S27. On the other hand, in a case where the acquisition unit 57 determines that the voltage difference indicating the difference between the operating voltage of the charging device 10 and the reference voltage of the charging device 10 is less than the second threshold (step S72: No), the processing proceeds to Processing B.

### Second Modified Example

In a case where the charging device 10 complies with the MPP standard, there is a procedure of estimating the coupling coefficient k when the wireless charging starts, and thus, the second estimation equation may be derived using the estimated coupling coefficient. For example, the misalignment characteristic calculation unit 53 estimates a coupling coefficient k3 at a time point t1. Further, the misalignment characteristic calculation unit 53 estimates a coupling coefficient k4 at a time point t2. Here, the misalignment characteristic calculation unit 53 calculates the coupling coefficient k in the future by using an expression k = α * k3 + β * k4. Here, α + β = 1.

As a result, the misalignment characteristic calculation unit 53 can derive the second estimation equation without using the graph G2 and the graph G3 illustrated in FIG. 4. Therefore, the charging device 10 can estimate the limit value of the operating voltage of the charging device 10 at an earlier timing.

### Third Modified Example

In the above-described embodiment, it has been described that the voltage threshold Vth of the charging device 10 is the associated value which is associated with the received power as illustrated in FIG. 8, but the voltage threshold Vth is not limited thereto. For example, the voltage threshold Vth is updated by sequential determination for each step, but there is a case where an extremely minute deviation within an allowable range that does not affect misalignment determination is accumulated. When the extremely minute deviation of the voltage threshold Vth continues to be accumulated, the misalignment determination accuracy may be lowered.

Therefore, for the voltage threshold Vth associated with the received power, a reference voltage threshold serving as a reference is set. In a case where the voltage threshold Vth is lower than the reference voltage threshold, the charging device 10 performs misalignment determination based on the voltage threshold Vth. In addition, in a case where the voltage threshold Vth is higher than the reference voltage threshold, the charging device 10 performs misalignment determination based on the reference voltage threshold. The reference voltage threshold may be set in advance or may be set using the coupling coefficient k.

### Fourth Modified Example

The charging device 10 may detect the misalignment between the power transmission coil 16 and the power reception coil 31 by arranging magnetic field sensors in the charging stand 19 so as to surround the periphery of the power reception coil 31 and acquiring a magnetic field intensity balance output from the magnetic field sensors. As a result, the charging device 10 can detect a misalignment during the wireless charging by arranging the magnetic field sensors.

### Fifth Modified Example

The charging device 10 may perform misalignment determination by using the efficiency E(t). Specifically, the charging device 10 moves the power transmission coil 16 according to a predetermined procedure (for example, up, down, left, and right). The charging device 10 calculates the received power of the power reception coil 31 based on the communication data received from the power reception coil 31 by the power transmission coil 16. Further, the charging device 10 compares the efficiency E(t) calculated during the wireless charging with the preset threshold Eth. Then, when the efficiency E(t) is lower than the threshold Eth, the charging device 10 determines that the misalignment of the terminal device 30 has occurred.

### Sixth Modified Example

The charging device 10 may include detection coils that detect the position of the power reception coil 31 of the terminal device 30 placed on the charging stand 19. In one example, the detection coils are provided at positions facing the power reception coil 31 of the terminal device 30 placed on the charging stand 19. In addition, the detection coils are arranged in a matrix in directions intersecting each other.

### Hardware Configuration

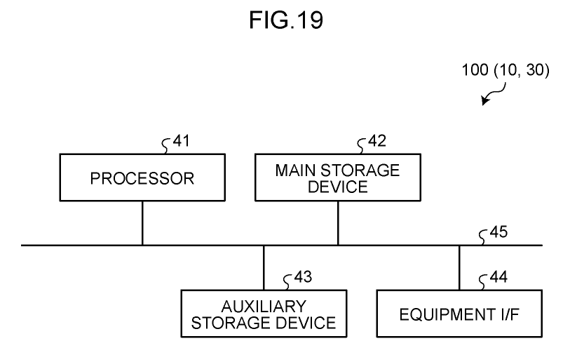

FIG. 19 is a diagram illustrating an example of a hardware configuration of the charging system 100 according to the embodiment and the modified examples. In the charging device 10 and the terminal device 30 of the charging system 100 of the above-described embodiment and modified examples, a processor 41, a main storage device 42, an auxiliary storage device 43, and an equipment I/F 44 are mutually connected by a bus 45 or the like, and the charging device 10 and the terminal device 30 of the charging system 100 of the above-described embodiment and modified examples have a hardware configuration using a normal computer.

The processor 41 is, for example, a central processing unit (CPU), and is a computation device that controls the charging device 10 and the terminal device 30 of the above-described embodiment and modified examples. The main storage device 42 is, for example, a random access memory (RAM), and stores data necessary for various types of processing performed by the processor 41. The auxiliary storage device 43 is, for example, a read-only memory (ROM), and stores a computer program or the like that implements information processing performed by the processor 41. The main storage device 42 and the auxiliary storage device 43 are examples of the storage unit.

The equipment I/F 44 is an interface for various types of input/output and/or communication of the charging device 10 and the terminal device 30. The equipment I/F 44 may include a communication interface configured to be connectable to an external communication device that communicates with the charging device 10 and the terminal device 30 or configured to function as the communication device.

As the communication interface, a communication circuit for wired communication, such as a universal serial bus (USB) (registered trademark) or Ethernet (registered trademark), or a communication circuit for wireless communication compatible with various standards such as 3G, LTE, 4G, 5G, 6G, Wi-Fi (registered trademark), and Bluetooth (registered trademark) can be appropriately used.

In the charging device 10 and the terminal device 30 of the above-described embodiment and modified examples, the processor 41 reads the program from the auxiliary storage device 43 onto the main storage device 42 and executes the program, whereby the above-described respective functional units are implemented on the computer.

The program for performing each step of above-described processing performed by the charging device 10 and the terminal device 30 according to the above-described embodiment and modified examples may be stored in a hard disk drive (HDD). The program for performing each step of the above-described processing performed by the charging device 10 and the terminal device 30 according to the above-described embodiment and modified examples may be provided by being incorporated in the auxiliary storage device 43 in advance.

In addition, the program for performing the above-described processing performed by the charging device 10 and the terminal device 30 according to the above-described embodiment and modified examples may be stored in a computer-readable storage medium such as a CD-ROM, a CD-R, a memory card, a digital versatile disk (DVD), or a flexible disk (FD) as a file in an installable format or an executable format and provided as a computer program product. The program for performing the information processing performed by the charging device 10 and the terminal device 30 according to the above-described embodiment and modified examples may be stored on a computer connected to a network such as the Internet and provided by being downloaded via the network. Moreover, the program for performing the information processing performed by the charging device 10 and the terminal device 30 of the above-described embodiment and modified examples may be provided or distributed via a network such as the Internet.

According to at least one embodiment described above, the power efficiency in the wireless charging can be further improved as compared with the related art.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charging device performing wireless charging for a terminal device placed on a charging stand, the terminal device including a power reception coil to receive wirelessly transmitted power, the charging device comprising:
a power transmission coil configured to transmit power to the terminal device; and
a control circuit connected to the power transmission coil and configured to
acquire an operating voltage of the charging device and received power of the terminal device after the charging device starts the wireless charging for the terminal device,
calculate a first reference voltage of the charging device used for misalignment determination, and
determine a misalignment between the power transmission coil and the power reception coil based on a first voltage difference indicating a difference between the operating voltage of the charging device and the first reference voltage.

2. The charging device according to claim 1, wherein the control circuit is configured to, in a state where the received power is stable, determine that there is a misalignment when the first voltage difference is equal to or more than a voltage threshold, the voltage threshold indicating a difference between a first operating voltage of the charging device when there is a misalignment and a second operating voltage of the charging device when there is no misalignment.

3. The charging device according to claim 2, wherein the control circuit is configured to, in a state where the received power is stable, determine that there is a misalignment when the first voltage difference is equal to or more than the voltage threshold and there is no increase in received power.

4. The charging device according to claim 1, wherein the control circuit is configured to, in a state where the received power has decreased, determine that there is a misalignment when the first voltage difference is equal to or more than a voltage at which a change amount of the received power is in a given range.

5. The charging device according to claim 1, wherein the control circuit is configured to
calculate a second reference voltage of the charging device for the misalignment determination in a state where the received power has decreased, and
determine that there is a misalignment when a second voltage difference indicating a difference between the operating voltage of the charging device and the second reference voltage is equal to or more than a voltage threshold, the voltage threshold indicating a difference between a first operating voltage of the charging device when there is a misalignment and a second operating voltage of the charging device when there is no misalignment.

6. The charging device according to claim 1, wherein the control circuit is configured to
calculate a limit value of the operating voltage of the charging device in a state where the received power has decreased, and
determine that there is a misalignment when the operating voltage of the charging device is equal to or higher than the limit value.

7. The charging device according to claim 1, wherein the control circuit is configured to, in a state where the received power is stable, determine that there is a misalignment when the first voltage difference is equal to or more than a voltage threshold and the first voltage difference is equal to or more than a first threshold, the voltage threshold indicating a difference between a first operating voltage of the charging device when there is a misalignment and a second operating voltage of the charging device when there is no misalignment.

8. The charging device according to claim 1, wherein the control circuit is configured to, in a state where the received power is stable, determine that there is a misalignment when the first voltage difference is equal to or more than a voltage threshold and the first voltage difference is equal to or more than a second threshold, the voltage threshold indicating a difference between a first operating voltage of the charging device when there is a misalignment and a second operating voltage of the charging device when there is no misalignment.

9. The charging device according to claim 1, wherein the control circuit is configured to
set a parameter including the first reference voltage and reference received power of the terminal device, and
initialize the parameter after starting the wireless charging.

10. The charging device according to claim 9, wherein the control circuit is configured to, in a state where the received power is stable and the parameter has not yet been determined, set the first reference voltage as the operating voltage and set the reference received power as the received power.

11. The charging device according to claim 9, wherein the control circuit is configured to, in a state where the received power has increased, set the first reference voltage as the operating voltage and set the reference received power as the received power when the operating voltage is higher than a sum of the first reference voltage and a first change amount, and the received power is higher than a sum of the reference received power and a second change amount.

12. The charging device according to claim 9, wherein the control circuit is configured to, in a state where the received power has increased, set the first reference voltage as the operating voltage and set the reference received power as the received power when the operating voltage is lower than a difference between the first reference voltage and a first change amount, and the received power is lower than a difference between the reference received power and a second change amount.

13. The charging device according to claim 9, wherein the control circuit is configured to
calculate a second reference voltage of the charging device for the misalignment determination in a state where the received power has decreased, and
set the operating voltage to the second reference voltage and set the received power to the reference received power when
a second voltage difference indicating a difference between the operating voltage of the charging device and the second reference voltage is less than a voltage threshold indicating a difference between a first operating voltage of the charging device when there is a misalignment and a second operating voltage of the charging device when there is no misalignment,
the operating voltage is higher than a sum of the second reference voltage and a first change amount, and
the received power is higher than a sum of the reference received power and a second change amount.

14. The charging device according to claim 9, wherein the control circuit is configured to
calculate a second reference voltage of the charging device for the misalignment determination in a state where the received power has decreased, and
set the operating voltage to the second reference voltage and set the received power to the reference received power when
a second voltage difference indicating a difference between the operating voltage of the charging device and the second reference voltage is less than a voltage threshold indicating a difference between a first operating voltage of the charging device when there is a misalignment and a second operating voltage of the charging device when there is no misalignment,
the operating voltage is lower than a difference between the second reference voltage and a first change amount, and
the received power is lower than a difference between the reference received power and a second change amount.

15. The charging device according to claim 9, wherein the control circuit is configured to
calculate a limit value of the operating voltage of the charging device in a state where the received power has decreased, and
set the first reference voltage as the operating voltage and set the reference received power as the received power when
the operating voltage of the charging device is lower than the limit value,
the operating voltage is higher than a sum of the first reference voltage and a first change amount, and
the received power is higher than a sum of the reference received power and a second change amount.

16. The charging device according to claim 9, wherein the control circuit is configured to
calculate a limit value of the operating voltage of the charging device in a state where the received power has decreased, and
set the first reference voltage as the operating voltage and set the reference received power as the received power when
the operating voltage of the charging device is lower than the limit value,
the operating voltage is lower than a difference between the first reference voltage and a first change amount, and
the received power is lower than a difference between the reference received power and a second change amount.

17. The charging device according to claim 1, wherein the control circuit is configured to, after determining that there is a misalignment, control at least one of stop of the power of the power transmission coil or CLOAK processing.
